(19) United States
(12) Patent Application Publication
(10) Pub. No.: US 2026/0023508 A1
(43) Pub. Date: Jan. 22, 2026

(54) STORAGE OF LARGE DATASETS ACROSS DEVICES

(71) Applicant: Valassis Digital Corp., San Antonio, TX (US)

(72) Inventors: Anton Vladimir Bezuglov, Cary, NC (US); Ashleigh Linnea Thomas, Portland, ME (US); Gurcan Comert, Columbia, SC (US); Klevis Aliaj, Katy, TX (US)

(21) Appl. No.: 19/271,287

(22) Filed: Jul. 16, 2025

Related U.S. Application Data
(60) Provisional application No. 63/673,093, filed on Jul. 18, 2024.

(51) Int. Cl. G06F 3/06

(52) U.S. Cl. CPC G06F 3/067; G06F 3/0604; G06F 3/0656

(57) ABSTRACT

A plurality of operation-servers are configured to perform operations that produce operation-data having at least two dimensions of information. A second plurality of index-servers are configured to: maintain a datastore; receive a stream of the incoming operation-data; determine if the ingestion buffer contains sufficient incoming operation-data to be moved to a storage layer as a databank; move the ingestion buffer to a storage layer as a databank; determine if a given storage layer contains sufficient databanks to be compacted and moved to a higher layer; combine each databank in the given layer into a databank-union; identify pairs of operation-data in the databank-union based on a multidimensional distance measure between operation-data of the databank-union; color a first operation-data of the pair a first color; color a second operation-data of the pair a second color; create in a higher storage layer, a new databank.

### CLAIM OF PRIORITY

This application claims priority to U.S. Provisional Application Ser. No. 63/673,093, filed on Jul. 18, 2024, the entire contents of which are hereby incorporated by reference.

### TECHNICAL FIELD

This document relates to computer technology to manage large datasets, which can be generated in networked computing systems that generate large volumes of data by their operation.

### BACKGROUND

Computer telemetry includes the collection of measurements or other data at remote points and transmission to receiving equipment for monitoring. In distributed computing environments, this telemetry can include collection of data related to a program's execution, internal state, and communications among components.

Metadata can include data that provides information about other data. Descriptive metadata can include information about a resource. Structural metadata can include information about how compound objects are put together. Administrative metadata can include information for management of computing resources.

### SUMMARY

This document describes technology that can be used to effectively collect large datasets, including data that is being consistently created or updated. For example, when many servers simultaneously perform an operation over and over, they can create operation data that is large (due to the number of operations) and hard to use (due to being spread out over the various servers). This technology includes a process for compacting the data at each server, and then reporting the compacted data to centralized repositories.

As a server operates, it creates operation data that records the operation results and/or metadata about the operation. The server can store this operation data as it is created, and periodically compress it in some cases. Then, the server can report the operation data to centralized repositories that store the compressed operation data, compressing it more as needed.

The compressing described here can include processes that take advantage of the structured, multidimensional nature of the operation data. For example, datasets can be compressed using a coloring process that maintains certain statistical properties of the data, maintains mergeability of the data, but that reduces the amount of data stored. Sketches of the operational data can be created, which grow slowly compared to growth of the data itself. For example, as the operational data grows, the sketch of the data can grow at a slower rate such as O(logN). This technology can advantageously work on moving streams of data. Unlike other processes, such as some sampling processes, trends in the data can be preserved for analysis. When a stream of data includes a trend modified by a cycle, or a trend modified by a random walk, this process can analyze short windows of the data in a way that preserves the trend. With sampling, for example, a much larger sampling window is used to span across at least one cycle, or more, or to collect sufficient data samples to separate the signal of the trend from the noise of the random walk.

This technology can preserve mergeability of the data sketches. For example, two sketches can be combined using the same (or similar) processes as is used to compact a sketch. This can allow for parallel data processing across multiple physical devices or memory structures, and can allow the process to be used on streaming data that is continually generated or updated.

This technology allows for analysis of multidimensional data, which makes it suitable for a wide range of typical computer operations. For example, data is often created in a 2-tuple with one data value and one metadata value. For example, a [result, timestamp] pair can be used to record time series data from sensor operations, financial transactions, or network telemetry used for network optimization or security analysis.

While the sketch does not preserve all the operation data, it can preserve statistical properties of all the data, using less memory than it would take to store the data itself. For example, regular and normal ranks along one single dimension of a multidimensional dataset can be found, quantiles along the single dimension can be found, and approximations of the data can be provided that, while not the exact data, can be similar enough for many uses (e.g., losing some precision in timestamps (e.g., seconds) may be acceptable for uses that analyze larger time windows (e.g., minutes or hours).

In some aspects, the techniques described herein relate to a system for processing data of a computer network, the system including: a plurality of operation-servers, each operation-server including at least one processor and memory, each operation-server configured to perform operations that produce operation-data having at least two dimensions of information; a second plurality of index-servers, each index-server including at least one second processor and second memory, each index-server configured to: maintain a datastore for the operation-data, the datastore including: a ingestion buffer configured to store incoming operation-data; one or more databanks configured to store operation-data, the databanks being arranged in one or more storage layers of the datastore; for each storage layer, an associated storage weight that indicates a weight to be applied to each operation-data in the associated storage layer; receive a stream of the incoming operation-data from at least some of the operation-servers; add the incoming operation-data to the ingestion buffer; determine if the ingestion buffer contains sufficient incoming operation-data to be moved to a storage layer as a databank; responsive to determining that the ingestion buffer contains sufficient incoming operation-data to be moved to a storage layer as a databank, move the ingestion buffer to a storage layer as a databank; determine if a given storage layer contains sufficient databanks to be compacted and moved to a higher layer; responsive to determining that the given storage layer contains storage layer contains sufficient databanks to be compacted: combine each databank in the given layer into a databank-union; identify pairs of operation-data in the databank-union based on a multidimensional distance measure between operation-data of the databank-union; color a first operation-data of the pair a first color; color a second operation-data of the pair a second color; create in a higher storage layer, a new databank including the first operation-data of the first color while discarding the second operation-data of the second color.

In some aspects, the techniques described herein relate to a system, wherein the operation-server is a content-service server configured to create the operation-data to store a transaction-value in a first dimension of information and a transaction-time in a second dimension of information.

In some aspects, the techniques described herein relate to a system, wherein the transaction-value is one of the group consisting of i) network delay for a transaction; ii) computational resources used to perform the transaction; iii) monetary cost for the transaction; iv) geographic location of the transaction to reflect a geolocation associated with the transaction; and v) a logical location for the transaction to reflect a location of a network service associated with the transaction; and vi) a network address for the transaction.

In some aspects, the techniques described herein relate to a system, wherein the multidimensional distance measure is a Euclidian distance to represent a root value of a sum of distances in each dimension taken to an exponent.

In some aspects, the techniques described herein relate to a system, wherein the multidimensional distance is selected from a plurality of possible distances based on at least one of the group consisting of i) a count of dimensions of the operation-data, ii) a data-structure of information in at least one of the dimensions of the operation-data; iii) a determination that a dimension of the operation-data is discrete; and iv) a determining that a dimension of the operation-data is continuous.

In some aspects, the techniques described herein relate to a system, wherein the operation-data has a same number of dimensions as a number of colors used by the index-servers.

In some aspects, the techniques described herein relate to a system, wherein the operation-data has more dimensions than a number of colors used by the index-servers.

In some aspects, the techniques described herein relate to a system, wherein each index-server is further configured to: receive a query for operation-data; generate responsive data in the datastore using the operation-data modified by the storage weights; and respond to the query using the responsive data.

In some aspects, the techniques described herein relate to a system, wherein the each index-server is further configured to: store one or more point-range records that record ranges for operation-data stored in the storage layers; and to generate the responsive data in the datastore using the operation-data modified by the storage weights, the index-server is further configured to use the point-range records.

In some aspects, the techniques described herein relate to a system, wherein each index-server is further configured to: determine that creating, in a higher storage layer, the new databank has caused the higher storage layer to contain sufficient databanks to be compacted and moved to a second-higher layer; and responsive to determining that the higher layer contains sufficient databanks to be compacted: combine each databank in the higher layer into a databank-union; identify pairs of operation-data in the databank-union based on a multidimensional distance measure between operation-data of the databank-union; color a first operation-data of the pair a first color; color a second operation-data of the pair a second color; create in a second-higher storage layer, a new databank including the first operation-data of the first color while discarding the second operation-data of the second color.

In some aspects, the techniques described herein relate to a system, wherein the system further includes at least one aggregation-server including at least one third processor and third memory, each aggregation-server configured to: maintain an aggregating-datastore for the operation-data, the aggregating-datastore including: one or more aggregating-databanks configured to store operation-data, the aggregating-databanks being arranged in one or more aggregating layers of the aggregating-datastore for each aggregating layers, an associated aggregating weight that indicates a weight to be applied to each operation-data in the associated aggregating layer; receive, from an index-server, a databank and an associated storage weight; add the databank as an aggregating-databank to the aggregating-datastore in an aggregating layer selected based on the associated storage weight.

In some aspects, the techniques described herein relate to a system, wherein each index-server is configured to send, to the at least one aggregation-server, a databank from a top storage layer and the associated storage weight for the top storage layer.

In some aspects, the techniques described herein relate to a system, wherein the aggregation-server is further configured to: determine if a given aggregation layer contains sufficient aggregating-databanks to be compacted and moved to a higher layer; and responsive to determining that a given aggregation layer contains sufficient aggregating-databanks to be compacted and moved to a higher layer: combine each aggregating-databank in the given aggregating layer into an aggregating-union; identify pairs of operation-data in the aggregating-union based on the multidimensional distance measure between operation-data of the aggregating-union; color a first operation-data of the pair a first color; color a second operation-data of the pair a second color; create in a higher aggregating layer, a new aggregating-databank including the first operation-data of the first color while discarding the second operation-data of the second color.

In some aspects, the techniques described herein relate to a device including at least one processor and memory, the device configured to: maintain a datastore for operation-data having at least two dimensions of information, the datastore including: a ingestion buffer configured to store incoming operation-data; one or more databanks configured to store operation-data, the databanks being arranged in one or more storage layers of the datastore; for each storage layer, an associated storage weight that indicates a weight to be applied to each operation-data in the associated storage layer; receive a stream of the incoming operation-data; add the incoming operation-data to the ingestion buffer; determine if the ingestion buffer contains sufficient incoming operation-data to be moved to a storage layer as a databank; responsive to determining that the ingestion buffer contains sufficient incoming operation-data to be moved to a storage layer as a databank, move the ingestion buffer to a storage layer as a databank; determine if a given storage layer contains sufficient databanks to be compacted and moved to a higher layer; responsive to determining that the given storage layer contains sufficient databanks to be compacted: combine each databank in the given layer into a databank-union; identify pairs of operation-data in the databank-union based on a multidimensional distance measure between operation-data of the databank-union; color a first operation-data of the pair a first color; color a second operation-data of the pair a second color; create in a higher storage layer, a new databank including the first operation-data of the first color while discarding the second operation-data of the second color.

In some aspects, the techniques described herein relate to a device including at least one processor and memory, the device configure to: maintain an aggregating-datastore for operation-data, the aggregating-datastore including: one or more aggregating-databanks configured to store operation-data, the aggregating-databanks being arranged in one or more aggregating layers of the aggregating-datastore for each aggregating layers, an associated aggregating weight that indicates a weight to be applied to each operation-data in the associated aggregating layer; receive, from an index-server, a databank and an associated storage weight; add the databank as an aggregating-databank to the aggregating-datastore in an aggregating layer selected based on the associated storage weight.

In some aspects, the techniques described herein relate to a system for processing data of a computer network, the system including one or more computing devices including at least one processor and memory, the one or more computing devices configured to create: a plurality of operation-services, each operation-service configured to perform operations that produce operation-data having at least two dimensions of information; a second plurality of index-services, each index-service configured to: maintain a datastore for the operation-data, the datastore including: a ingestion buffer configured to store incoming operation-data; one or more databanks configured to store operation-data, the databanks being arranged in one or more storage layers of the datastore; for each storage layer, an associated storage weight that indicates a weight to be applied to each operation-data in the associated storage layer; receive a stream of the incoming operation-data from at least some of the operation-services; add the incoming operation-data to the ingestion buffer; responsive to determining that the ingestion buffer contains sufficient incoming operation-data to be moved to a storage layer as a databank, move the ingestion buffer to a storage layer as a databank; responsive to determining that the ingestion buffer contains sufficient incoming operation-data to be moved to a storage layer as a databank; determine if a given storage layer contains sufficient databanks to be compacted and moved to a higher layer; responsive to determining that the given storage layer contains sufficient databanks to be compacted: combine each databank in the given layer into a databank-union; identify pairs of operation-data in the databank-union based on a multidimensional distance measure between operation-data of the databank-union; color a first operation-data of the pair a first color; color a second operation-data of the pair a second color; create in a higher storage layer, a new databank including the first operation-data of the first color while discarding the second operation-data of the second color.

Other features, aspects and potential advantages will be apparent from the accompanying description and figures.

### DESCRIPTION OF DRAWINGS

FIG. 1 shows an example system for processing data of a computer network.

FIG. 2 shows an example of data used in processing data of a computer network.

FIG. 3 shows an example process for compacting a databank of operation data.

FIG. 4 shows an example process for processing data of a computer network.

FIG. 5 is a schematic diagram that shows an example of a computing device and a mobile computing device.

Like reference symbols in the various drawings indicate like elements

### DETAILED DESCRIPTION

A multivariate sketch is created to store multidimensional data while preserving mergability and useful statistical properties. For example, an array of servers can operate to perform various transactions, producing large amounts of data. This data can be compressed into sketches that lose some of the data-thus advantageously becoming smaller to store-while still maintaining various properties that can be used to analyze the data of the transaction. In this way, the functioning of the computer itself can be improved.

For example, an array of servers can be geographically distributed to quickly serve content to requesting user, track what content is being served, execute financial transactions related to the serving of content, etc. Because of the volume of clients, the rate of transactions across all servers can be very high. Analysis of the transactions can be desired to optimize various parameters of the transactions, service, network configurations, etc. However, running queries across all of the data and metadata may be infeasible because, by the time that a query is finished, the underlying details have changed. Techniques such as subsampling may not be adequate for these uses, because trends in the data can be missed by the sampling process, resulting in erroneous analytics based on poor data validity.

This document describe technology that can handle the large, moving datasets found in these kinds of networked operations. By using data sketches on multidimensional data, information about the data, and the relationships between the different dimensions, can be preserved for useful analysis while data size can be reduced compared to the raw data or subsampled data.

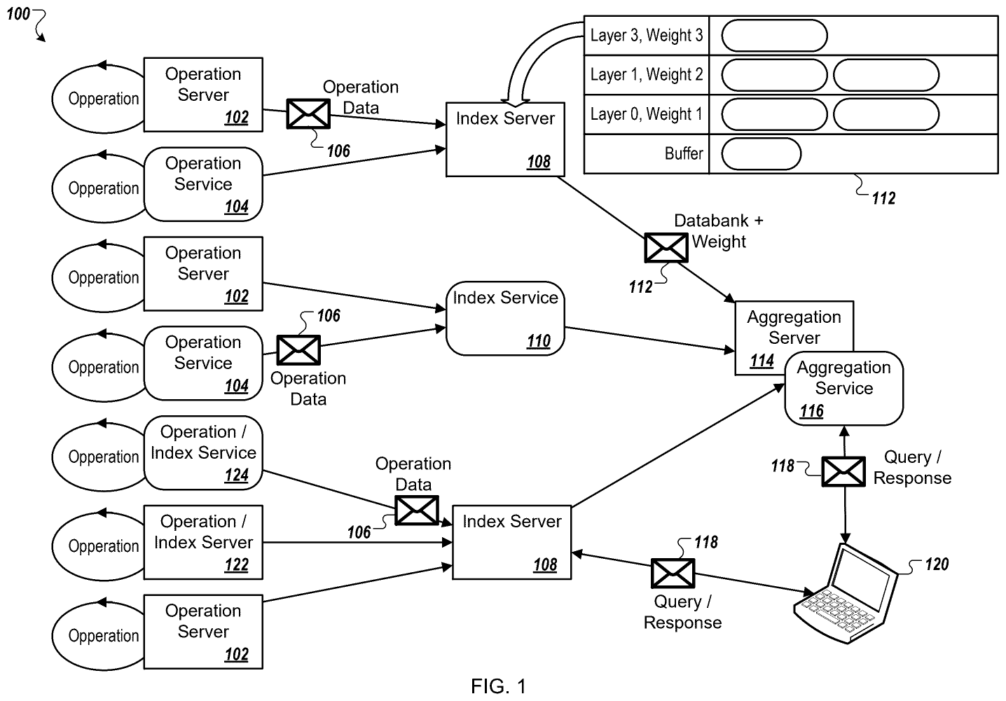

FIG. 1 shows an example system 100 for processing data of a computer network. In the system 100, operation servers 102 and/or operation services 104 can perform operations such as serving data, performing transactions, run scripts, host microservices, etc., which can create operation data 106. Index servers 108 and/or index services 110 can collect and compress the operation data 106 weight objects 112. An aggregation server 114 and/or aggregation service 116 can aggregate the databank and weight objects 112 and communicate queries and responses 118 with client devices 120. In some cases, various elements may be combined into a single element, such as an operation/index server 122 or operation/index service 124.

The servers 102, 108, and 114 can include physical and virtual machines that include processors, memory, and other physical and virtual components to perform various computing operations. Services 104, 110, and 116 can include hosted services, microservices, and other software that is not tied directly to one hardware platform or device. Use of servers 102, 108, and 114 can be advantageous, for example, in situations when specific hardware is required (e.g., true random number generator, secure-execution environments), when control of geographic location is required (e.g., to reduce network lag with clients, to comply with data privacy laws), and in other situations. Use of services 104, 110, and 114 can be advantageous, for example, in situations where parallelized process is used when a dataset size is too large for a single device, for example to increase performance, or because the data does not fit into the memory of a single server.

The operation servers 102 and operation services 104 can perform operations that product operation data 106 that has at least two dimensions. For example, the operation data 106 can store a transaction data (e.g., results of an operation) in one dimension, and metadata (e.g., timestamps) in another dimension. Additional dimensions are possible, depending on the particulars of the operations. Examples of the operation data 106 can include, but is not limited to, storing a transaction value in one dimension and a transaction time in a second dimension.

For example, an operation can include testing a network delay between a client and operation server 102 or operation service 104. In such a case, the network delay can be stored in on dimension and the time of the test in a second dimension.

For example, an operation can include running a user-supplied script in a hosted environment. In such a case, a record of the computational resources used to perform the transaction can be stored in one of the dimensions.

For example, an operation can include advertising content can be served based on a winning bid to an auction. In such a case, the monetary cost of the transaction can be stored in a first dimension, and a timestamp of the service can be stored in the second dimension.

For example, a data object stored in hosted storage may have a revised access control list changed in a transaction. In such a case, the change to the access control list can be stored in the first dimension, and a timestamp of the change can be stored in a second dimension. In such cases, a distance function can be created to determine the distances between two access control lists. While the particular implementations of the distance function can vary depending on the format of the access control lists, the distance function can generally be thought of a measure of how similar or different the two access control lists are. For example, a pair of access control lists that only differ by adding one user to one permission list can have a lower distance than a pair of access control lists that differ by having many users in one list but not the other.

For example, a data object can be stored in a logical location in hosted storage. In such an example, a file path for the storage location can be stored in a first dimension, and a timestamp of the storage event can be stored in the second dimension.

For example, a data transmission from a sender and receiver can be performed to a data message from one address to another, for example using Internet Protocol (IP) addresses. In such an example, the IP addresses can be stored in two dimensions, and a timestamp can be stored in a third dimension. In such a case, a distance metric such as hamming distance can be used to find the distance between two IP addresses.

The index servers 108 and index services 110 can receive, from the operation server 102 or operation service 104, operation data 106. These index servers 108 and index services 108 can then create indexes based on the reported operation data 106. For example, each index server 108 and index service 110 may be assigned some of the operation servers 102 or operation services 104. Those assigned operation servers 102 or operation services 104 can then report to their assigned index server 108 and index service 110, which can create their index for the assigned operation servers 102 or operation services 104.

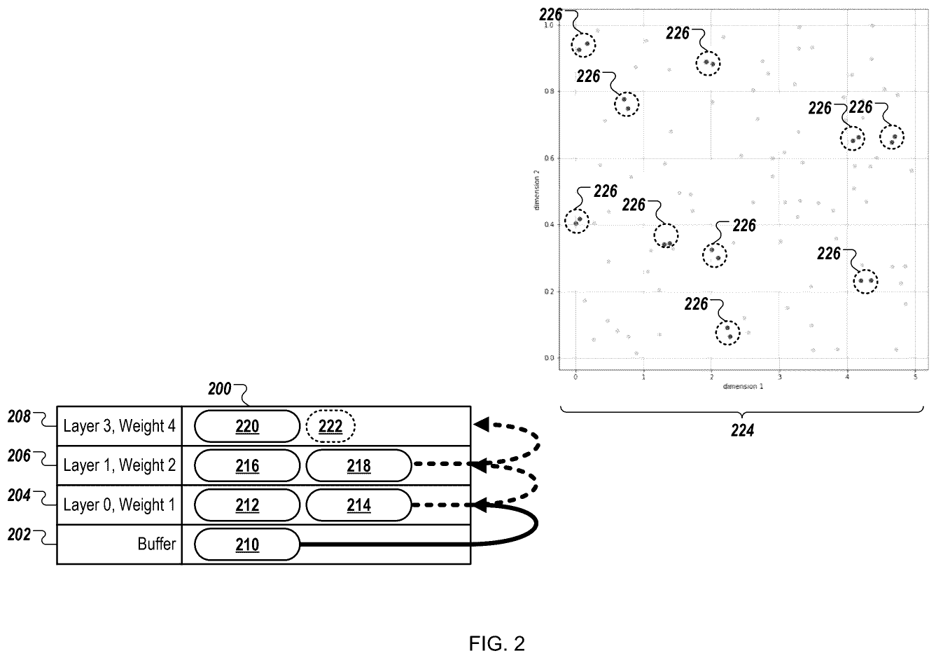

These indexes can be stored as sketches in databanks and weights 112 (describe in more detail with respect to FIG. 2 below) and reported to an aggregation server 114 and/or an aggregation service 116. The aggregation server 114 and/or aggregation service 116 can combine the received sketches (e.g., one or more databank and weights 112) into a single index for the entire system. Then, a client 120 can send queries and receive responses 118 with the index servers 108, index services 110, aggregations server 114, and/or aggregation service 116. For example, the client 120 can query for a timeseries of price data or access control lists changes.

FIG. 2 shows an example of data 200 used in processing data of a computer network. For example, the index servers 108, index services 110, aggregations server 114, and/or aggregation service 116 can use the data 200 to store the databank and weight 112.

The data 200 can include a number of layers, with four layers 202-208 shown in this example. Each layer 202-208 can store a fixed volume of data (e.g., a count of datapoints such as 1024, 2056, another n\hat{ }2 number, or another number that is not an n\hat{ }2 number), and each layer can have a fixed number of databanks, depending on the available storage resources and configurations of the device storing the data 200. As will be appreciated, other scheme for data size can be used, such as size on disk, number of fields, etc. On the lowest level, level 202, a buffer 210 can be used to store incoming data. For example, as the index server 108 receives operation data 106, the index server 108 can store the incoming operation data 106 in a buffer 210. When the buffer 210 is full, the data 200 can be compacted by moving the buffer 210 up a layer to layer 204 as a new datastore and starting a new buffer. As will be appreciated, the data 200 can be configured so that new data is added only to the buffer 210 and not layers higher in the data 200.

The layers 204-208 can store databanks 212-222. Each databank 212-222 can store up to the maximum size allocated for the datastores. The data 200 can be compacted, including but not limited when a databank 212-222 becomes full, when spare processing resources are available, etc.

For example, when the buffer 210 becomes full, compacting the data 200 can include moving the buffer 210 into layer 204 as a databank. However, doing so will cause the layer 204 to become full (or over-full). In such a case, the data in layer 204 (i.e., databanks 210-214) can be compared and moved to layer 206. This causes the layer 206 to become full (or over-full), causes iterated compactions and movement, until a new databank 222 is added to the layer 208.

Each layer 202-208 can have associated a weight, used to describe the relative weight of each datapoint in a databank in the layer. For layers 202 and 204, the weight can be assigned a value of “1” to indicate that each stored data point in the databanks 210-214 are associate from only a single operation data 106. However, in compacting data in the layer 204, some of the data is removed, with the remaining data having a higher weight.

For example, a layer 224 is shown rendered into a two-dimensional grid. If the layer 224 is to be compacted, near-neighbor datapoints can be identified and colored. As shown, each group 226 contains two datapoints. One of the datapoints in each group 226 is colored a first color (e.g., red) and the other datapoint in the group 226 is colored a second color (e.g., green). When compacted, all of the datapoints of one color (e.g., the first color red) can be dropped, while all of the datapoints of the other color (e.g., the second color green) can be moved to the next layer up. Because the next layer will have a higher weight (e.g., twice the current weight), the preserved data points (e.g., half of the groups' datapoints) will have the higher weight (e.g., twice the weight, preserving the total weight for the group 226 through the promotion process). While this description use the term “color” to describe this process, it will be understood that other terms for this process can be used. For example, this process can sometime be referred to as tagging or identifying. Similarly, this process does not require rendering any of the datapoints in color or in any other way.

Points in the data 200 can have associated point ranges that indicate how much variance is in the set of other points that are summarized by a point. For example, the point ranges can be two n-tuples of point: one being the minimum n-tuple and the other being the maximum n-tuple. For each dimension, the corresponding minimum and maximum n-tuple corresponds to the smallest and largest values found among the corresponding dimensions in the summarized points. When coloring is performed (see below) these point ranges can be updated when needed to represent the updated ranges. A uniform distribution can be assumed and implemented by selecting any point between the tuples with equal chance. A normal distribution can be assumed and implemented by, for example, assuming the mean of the summarized points is at the stored point and storing an estimated standard deviation (or another number, such as three standard deviations). Then synthetic dataset of M*N datapoints can be selected from a normal distributions with that mean and standard deviation.

These point ranges can be used, for example, when responding to a query. For example, certain statistical measures may be taken that take into account not just the values stored by a point in a databank, but also the range of possible points. In some cases, the summarized data can be expanded using the point ranges. For example, to turn a summarized databank with M points and a weight N into a synthetic dataset of M*N datapoints, each datapoint can be sampled between the minimum and maximum N-tuple in each dimension. A random distribution can be assumed and implemented by selecting any point between the tuples with equal chance. A normal distribution can be assumed and implemented by selected based on a weighting function that would place, for example, the mean at the stored point and one standard deviation (or another number, such as three standard deviations) at the minimum and maximum n-tuple in each dimension.

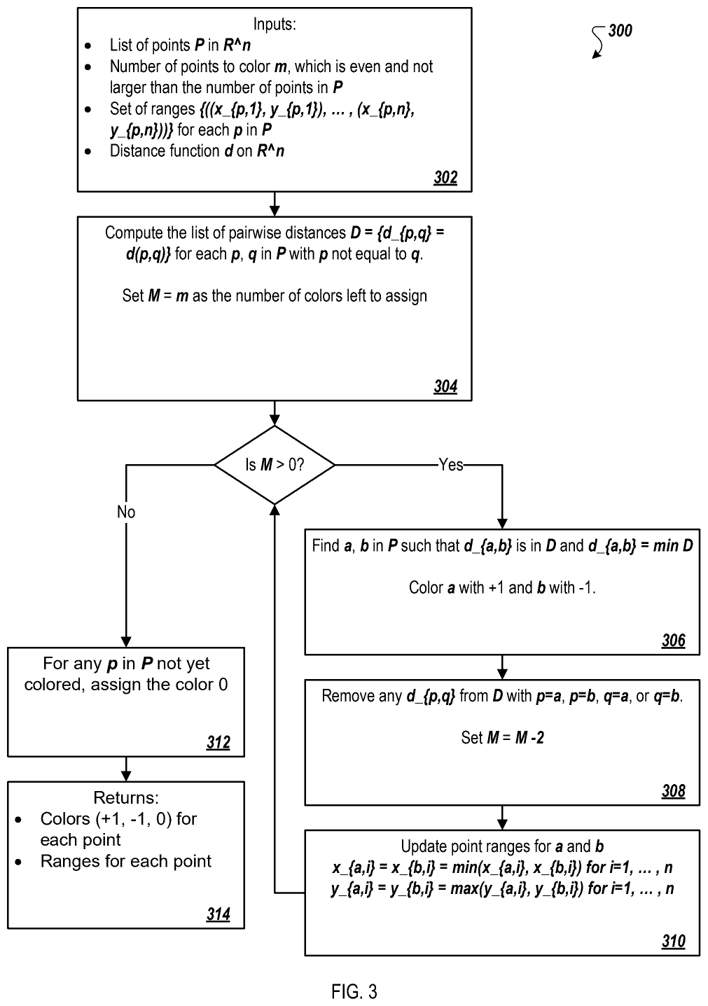

FIG. 3 shows an example process 300 for compacting a databank of operation data. For example, the servers 102, 108, 114 and/or the services 104, 110, 116 can perform the process 300 on the data 200 that is stored.

The process 300 can be used to combine each databank in a databank union. For example, in 302, the list of points P in R\hat{ }n can be all points in all databanks in a single layer (e.g., all data in databanks 210-214 in layer 204). As will be appreciated, this can create a dataset made up of datapoints that are from different databanks.

Pairs of operation data in the databank union are identified. For example, in 304, multidimensional distance measures are found between each pair of operation data. In some examples, this multidimensional distance measure can be a Euclidian distance to represent a root value of a sum of distances in each dimension taken to an exponent. In some examples, this multidimensional distance can be a different distance calculation. Depending on the type and format of the operation data, different types of distance calculations can be used. For example, the distance calculation can be selected from a group of possible distances based on at least one of the group consisting of i) a count of dimensions of the operation-data, ii) a data-structure of information in at least one of the dimensions of the operation-data; iii) a determination that a dimension of the operation-data is discrete; and iv) a determining that a dimension of the operation-data is continuous. While this document describes the use of distance measures and searching for low distances, other implementations can use similarity measures. Such cases can search for high similarities. As will be appreciated, many similarity measures are inverse distance measures, but other types of similarity measures may be used, including those that do not satisfy the triangle inequality.

A first operation data of the pair is tagged with a first value. For example, in 306, one of the two datapoints in the pair is tagged with a “+1” color value, while the other datapoint is tagged with a “−1” color value. The selection of which datapoint is assigned which color can be randomized or performed according to any appropriate test. For example, randomization can be used to reduce or eliminate inherent bias in data or algorithmic processes. In some cases, where each point is expected to be a representation of a standard distribution of values, the selected point may be the one found to be closer to the mean of the union of the two distributions. Colored operation data can be removed from consideration in 308, and the range of available operation data can be updated in 310. In some examples, the operation-data has the same number of dimensions as a number of colors used by the index-servers. For example, operation data with the two dimensions [value, timestamp] can be used, and two colors can be used. In some examples, the operation-data can have more dimensions than a number of colors used.

A new databank is created in a higher storage layer. For example, in 312, points that have not been given a value of “−1” and “+1” can be given a color of 0 or no color value. Then, in 314, each point color and range can be returned.

As described previously, moving some data to a higher level may cause the higher level to become full or overfull. In such cases, the process 300 can be repeated for the higher level(s).

Variations on the processes described here are possible. For example, other coloring techniques can be used, including but not limited to color techniques such as low-discrepancy coloring algorithms.

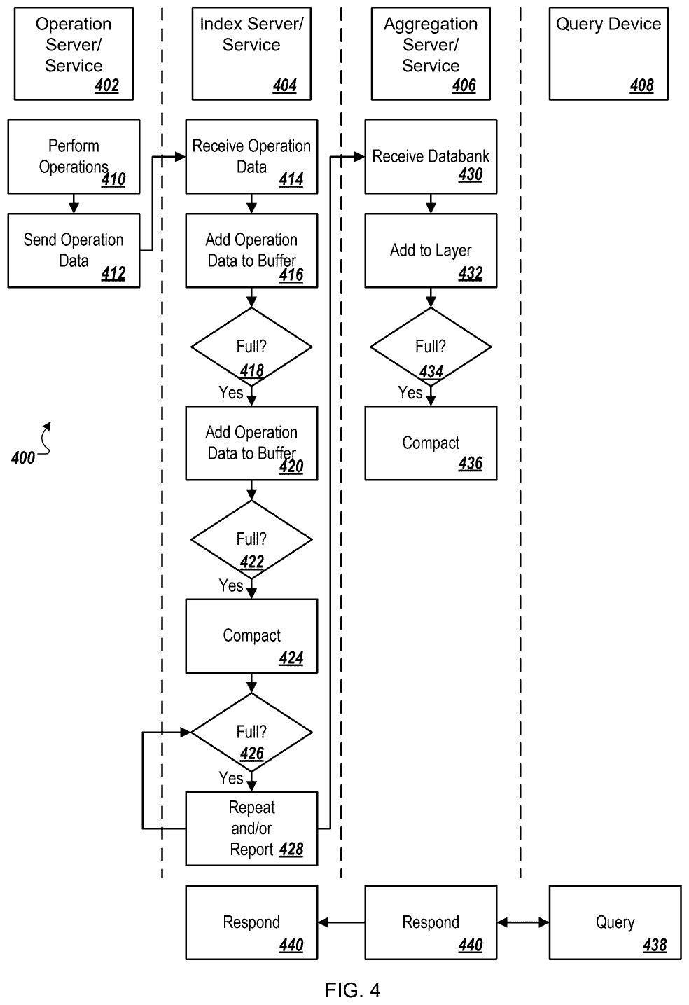

FIG. 4 shows an example process 400 for processing data of a computer network. In the process 400, operations servers/services 402 perform operations, which produces operation data. Index server/services 404 can create data sketches of the operation data, and an aggregation server/service 406 can collect those data sketches to make a single, centralized data sketch. A query device 408 can send queries to other elements to be run on data sketches.

Operation servers/services 402 can perform 410 operations. For example, a group of computing systems can work together to perform operations that produce operation data. These operations can include bidding on opportunities to serve content and executing transactions for the service of that content. In another example, a network security system can monitor data at various routers and edge devices and generate telemetry data for further analysis. In another example, automated vehicles can generate three-dimensional data of their environments with various sensors and determine if their environment has various waypoints or signs for navigation.

Operation servers/services 402 can send 412 operation data and the index servers/services 404 can receive 404 the index data. For example, the operation servers/services 402 can send data to the index servers/services 404 across one or more network connections. This data transmission can include streams of data that are continuously being transmitted, intermittently being transmitted, being transmitted upon request from the receiver, etc.

Index servers/services 404 can add 416 the incoming operation data to an ingestion buffer. For example, data from the incoming streams can be added into a buffer 210 in the data 200 as it is being received. This can include adding all the incoming data, or can include filtering the data to only include data that meets particular criteria (e.g., operations of a particular type, operation data that falls within a particular range).

Index servers/services 404 can determine 418 if the ingestion buffer contains sufficient incoming operation-data to be moved to a storage layer as a databank. For example, if the buffer 210 has a size limit of a number of datapoints and contains that number of datapoints or more, the index servers/service 404 can determine that the ingestion buffer is full and should be compacted.

If the ingestion buffer is full, index servers/services 404 can move 420 the ingestion buffer to a storage layer as a databank. For example, the ingestion buffer 210 can be change to a databank 210 and moved from the layer 202 to the layer 204.

Index servers/services 404 can determine 422 if a given storage layer contains sufficient databanks to be compacted and moved to a higher layer. For example, the layer 204 may have a size limit of 20 million datapoints, and adding the datastore 210 to the layer 204 may cause the layer to contain 30 million datapoints. In such an example, the index servers/services 404 can determine that the layer 204 is full and should be compacted.

Index servers/services 404 can, responsive to determining 422 that the given storage layer contains sufficient databanks to be compacted, compact 424 the full layer. For example, the index servers/service 404 can perform the operation 300 with the data in the layer 204.

Index servers/services 404 can determine 426 if other storage layers contain sufficient databanks to be compacted and moved to a higher layer. For example, compacting the layer 204 can result in the layer 206 holding more than the 20 gigabyte limit, and the index servers/services 404 can determine that the layer 206 is full.

Index servers/services 404 can, responsive to determining 422 that the given storage layer contains sufficient databanks to be compacted, repeat 428 the compaction and/or report the compaction. For example, the index server/service 404 can repeat the process 300 for the layer 206, and again and again should the subsequent layers be full. In addition or instead, the index servers/services 404 can report their sketches (e.g., one or more databank(s) such as all databanks, databanks of the top layer) to the aggregation server/services 406, and the aggregation server/service 406 receives 430 databanks from the index servers/services 404.

The aggregation server/service 406 adds 432 the databank(s) to a layer. For example, the aggregation server/service 406 may add the incoming databank(s) to a buffer 210 in a layer 202 stored in the aggregation server/service 406,

The aggregation server/service 406 can determine 434 if a given storage layer contains sufficient databanks to be compacted and moved to a higher layer. The aggregation server/service 406 can, responsive to determining 434 that the given storage layer contains sufficient databanks to be compacted, compact 436 the data. For example, as the layers of the aggregation server/service 406 become full, the aggregation server/service 406 can perform the compaction as needed to lower the amount of data in each layer.

The query device 408 sends 438 to the index servers/services 404 and/or the aggregation server/service 406 a query, and the index servers/services 404 and/or the aggregation server/service 406 can respond 440. For example, the query device 408 can send a query requesting a count of all transactions that occurred within a particular time window. The responding element can generate responsive data in the datastore using the operation-data modified by the storage weights; and respond to the query using the responsive data. For example, a count of each data object in a datastore with a timestamp within the window can be multiplied by the weight of the data object's layer and added to a return value to the query.

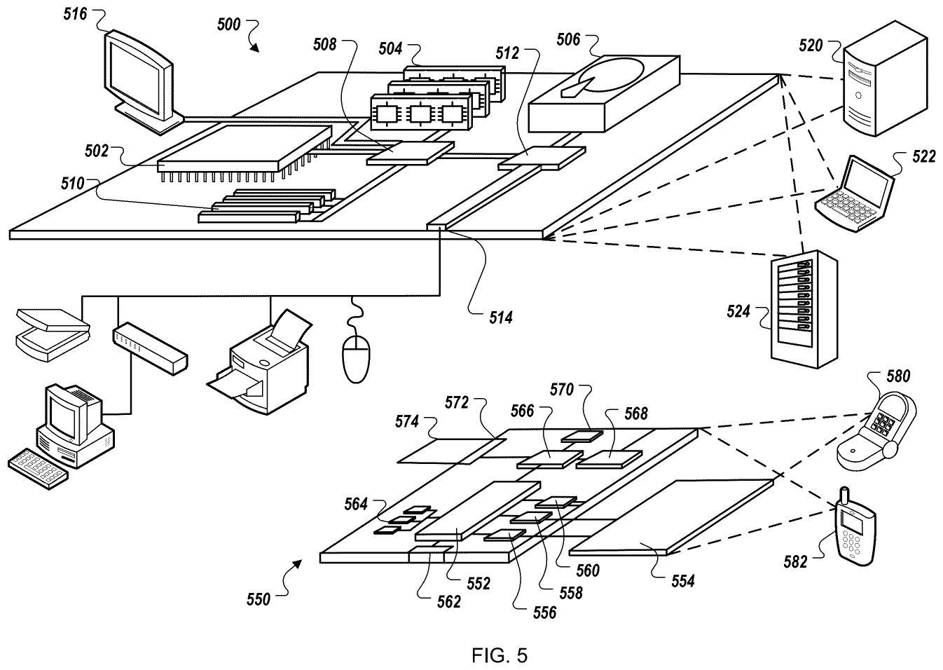

FIG. 5 shows an example of a computing device 500 and an example of a mobile computing device that can be used to implement the techniques described here. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 can also be another form of computer-readable medium, such as a magnetic or optical disk.

The storage device 506 is capable of providing mass storage for the computing device 500. In some implementations, the storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 504, the storage device 506, or memory on the processor 502.

The high-speed interface 508 manages bandwidth-intensive operations for the computing device 500, while the low-speed interface 512 manages lower bandwidth- intensive operations. Such allocation of functions is exemplary only. In some implementations, the high-speed interface 508 is coupled to the memory 504, the display 516 (e.g., through a graphics processor or accelerator), and to the high-speed expansion ports 510, which can accept various expansion cards (not shown). In the implementation, the low-speed interface 512 is coupled to the storage device 506 and the low-speed expansion port 514. The low-speed expansion port 514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 520, or multiple times in a group of such servers. In addition, it can be implemented in a personal computer such as a laptop computer 522. It can also be implemented as part of a rack server system 524. Alternatively, components from the computing device 500 can be combined with other components in a mobile device (not shown), such as a mobile computing device 550. Each of such devices can contain one or more of the computing device 500 and the mobile computing device 550, and an entire system can be made up of multiple computing devices communicating with each other.

The mobile computing device 550 includes a processor 552, a memory 564, an input/output device such as a display 554, a communication interface 566, and a transceiver 568, among other components. The mobile computing device 550 can also be provided with a storage device, such as a micro-drive or other device, to provide additional storage. Each of the processor 552, the memory 564, the display 554, the communication interface 566, and the transceiver 568, are interconnected using various buses, and several of the components can be mounted on a common motherboard or in other manners as appropriate.

The processor 552 can execute instructions within the mobile computing device 550, including instructions stored in the memory 564. The processor 552 can be implemented as a chipset of chips that include separate and multiple analog and digital processors. The processor 552 can provide, for example, for coordination of the other components of the mobile computing device 550, such as control of user interfaces, applications run by the mobile computing device 550, and wireless communication by the mobile computing device 550.

The processor 552 can communicate with a user through a control interface 558 and a display interface 556 coupled to the display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can provide communication with the processor 552, so as to enable near area communication of the mobile computing device 550 with other devices. The external interface 562 can provide, for example, for wired communication in some implementations, or for wireless communication in other implementations, and multiple interfaces can also be used.

The memory 564 stores information within the mobile computing device 550. The memory 564 can be implemented as one or more of a computer-readable medium or media, a volatile memory unit or units, or a non-volatile memory unit or units. An expansion memory 574 can also be provided and connected to the mobile computing device 550 through an expansion interface 572, which can include, for example, a SIMM (Single In Line Memory Module) card interface. The expansion memory 574 can provide extra storage space for the mobile computing device 550, or can also store applications or other information for the mobile computing device 550. Specifically, the expansion memory 574 can include instructions to carry out or supplement the processes described above, and can include secure information also. Thus, for example, the expansion memory 574 can be provide as a security module for the mobile computing device 550, and can be programmed with instructions that permit secure use of the mobile computing device 550. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 564, the expansion memory 574, or memory on the processor 552. In some implementations, the computer program product can be received in a propagated signal, for example, over the transceiver 568 or the external interface 562.

The mobile computing device 550 can communicate wirelessly through the communication interface 566, which can include digital signal processing circuitry where necessary. The communication interface 566 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 568 using a radio-frequency. In addition, short-range communication can occur, such as using a Bluetooth, WiFi, or other such transceiver (not shown). In addition, a GPS (Global Positioning System) receiver module 570 can provide additional navigation-and location-related wireless data to the mobile computing device 550, which can be used as appropriate by applications running on the mobile computing device 550.

The mobile computing device 550 can also communicate audibly using an audio codec 560, which can receive spoken information from a user and convert it to usable digital information. The audio codec 560 can likewise generate audible sound for a user, such as through a speaker, e.g., in a handset of the mobile computing device 550. Such sound can include sound from voice telephone calls, can include recorded sound (e.g., voice messages, music files, etc.) and can also include sound generated by applications operating on the mobile computing device 550.

The mobile computing device 550 can be implemented in a number of different forms, as shown in the figure. For example, it can be implemented as a cellular telephone 580. It can also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for processing data of a computer network, the system comprising:
a plurality of operation-servers, each operation-server comprising at least one processor and memory, each operation-server configured to perform operations that produce operation-data having at least two dimensions of information;
a second plurality of index-servers, each index-server comprising at least one second processor and second memory, each index-server configured to:
maintain a datastore for the operation-data, the datastore comprising:
an ingestion buffer configured to store incoming operation- data;
one or more databanks configured to store operation-data, the databanks being arranged in one or more storage layers of the datastore;
for each storage layer, an associated storage weight that indicates a weight to be applied to each operation-data in the associated storage layer;
receive a stream of the incoming operation-data from at least some of the operation-servers;
add the incoming operation-data to the ingestion buffer;
determine if the ingestion buffer contains sufficient incoming operation-data to be moved to a storage layer as a databank;
responsive to determining that the ingestion buffer contains sufficient incoming operation-data to be moved to a storage layer as a databank, move the ingestion buffer to a storage layer as a databank;
determine if a given storage layer contains sufficient databanks to be compacted and moved to a higher layer;
responsive to determining that the given storage layer contains sufficient databanks to be compacted:
combine each databank in the given layer into a databank- union;
identify pairs of operation-data in the databank-union based on a multidimensional distance measure between operation-data of the databank-union;
color a first operation-data of the pair a first color;
color a second operation-data of the pair a second color;
create in a higher storage layer, a new databank comprising the first operation-data of the first color while discarding the second operation-data of the second color.

2. The system of claim 1, wherein the operation-server is a content-service server configured to create the operation-data to store a transaction-value in a first dimension of information and a transaction-time in a second dimension of information.

3. The system of claim 2, wherein the transaction-value is one of the group consisting of i) network delay for a transaction; ii) computational resources used to perform the transaction; iii) monetary cost for the transaction; iv) geographic location of the transaction to reflect a geolocation associated with the transaction; and v) a logical location for the transaction to reflect a location of a network service associated with the transaction; and vi) a network address for the transaction.

4. The system of claim 1, wherein the multidimensional distance measure is a Euclidian distance to represent a root value of a sum of distances in each dimension taken to an exponent.

5. The system of claim 1, wherein the multidimensional distance is selected from a plurality of possible distances based on at least one of the group consisting of i) a count of dimensions of the operation-data, ii) a data-structure of information in at least one of the dimensions of the operation-data; iii) a determination that a dimension of the operation-data is discrete; and iv) a determining that a dimension of the operation-data is continuous.

6. The system of claim 1, wherein the operation-data has a same number of dimensions as a number of colors used by the index-servers.

7. The system of claim 1, wherein the operation-data has more dimensions than a number of colors used by the index-servers.

8. The system of claim 1, wherein each index-server is further configured to:
receive a query for operation-data;
generate responsive data in the datastore using the operation-data modified by the storage weights; and
respond to the query using the responsive data.

9. The system of claim 1, wherein each index-server is further configured to:
store one or more point-range records that record ranges for operation-data stored in the storage layers; and
to generate the responsive data in the datastore using the operation-data modified by the storage weights, the index-server is further configured to use the point-range records.

10. The system of claim 1, wherein each index-server is further configured to:
determine that creating, in a higher storage layer, the new databank has caused the higher storage layer to contain sufficient databanks to be compacted and moved to a second-higher layer; and
responsive to determining that the higher layer contains sufficient databanks to be compacted:
combine each databank in the higher layer into a databank-union;
identify pairs of operation-data in the databank-union based on a multidimensional distance measure between operation-data of the databank-union;
color a first operation-data of the pair a first color;
color a second operation-data of the pair a second color;
create in a second-higher storage layer, a new databank comprising the first operation-data of the first color while discarding the second operation-data of the second color.

11. The system of claim 1, wherein the system further comprises at least one aggregation-server comprising at least one third processor and third memory, each aggregation-server configured to:
maintain an aggregating-datastore for the operation-data, the aggregating- datastore comprising:
one or more aggregating-databanks configured to store operation- data, the aggregating-databanks being arranged in one or more aggregating layers of the aggregating-datastore;
for each aggregating layers, an associated aggregating weight that indicates a weight to be applied to each operation-data in the associated aggregating layer;
receive, from an index-server, a databank, and an associated storage weight;
add the databank as an aggregating-databank to the aggregating-datastore in an aggregating layer selected based on the associated storage weight.

12. The system of claim 11, wherein each index-server is configured to send, to the at least one aggregation-server, a databank from a top storage layer and the associated storage weight for the top storage layer.

13. The system of claim 11, wherein the aggregation-server is further configured to:
determine if a given aggregation layer contains sufficient aggregating-databanks to be compacted and moved to a higher layer; and
responsive to determining that a given aggregation layer contains sufficient aggregating-databanks to be compacted and moved to a higher layer:
combine each aggregating-databank in the given aggregating layer into an aggregating-union;
identify pairs of operation-data in the aggregating-union based on the multidimensional distance measure between operation-data of the aggregating- union;
color a first operation-data of the pair a first color;
color a second operation-data of the pair a second color;
create in a higher aggregating layer, a new aggregating-databank comprising the first operation-data of the first color while discarding the second operation-data of the second color.

14. A device comprising at least one processor and memory, the device configured to:
maintain a datastore for operation-data having at least two dimensions of information, the datastore comprising:
an ingestion buffer configured to store incoming operation-data;
one or more databanks configured to store operation-data, the databanks being arranged in one or more storage layers of the datastore;
for each storage layer, an associated storage weight that indicates a weight to be applied to each operation-data in the associated storage layer;
receive a stream of the incoming operation-data;
add the incoming operation-data to the ingestion buffer;
determine if the ingestion buffer contains sufficient incoming operation- data to be moved to a storage layer as a databank;
responsive to determining that the ingestion buffer contains sufficient incoming operation-data to be moved to a storage layer as a databank, move the ingestion buffer to a storage layer as a databank;
determine if a given storage layer contains sufficient databanks to be compacted and moved to a higher layer;
responsive to determining that the given storage layer contains sufficient databanks to be compacted:
combine each databank in the given layer into a databank-union;
identify pairs of operation-data in the databank-union based on a multidimensional distance measure between operation-data of the databank- union;
color a first operation-data of the pair a first color;
color a second operation-data of the pair a second color;
create in a higher storage layer, a new databank comprising the first operation-data of the first color while discarding the second operation-data of the second color.

15. A device comprising at least one processor and memory, the device configure to:
maintain an aggregating-datastore for operation-data, the aggregating-datastore comprising:
one or more aggregating-databanks configured to store operation- data, the aggregating-databanks being arranged in one or more aggregating layers of the aggregating-datastore;
for each aggregating layers, an associated aggregating weight that indicates a weight to be applied to each operation-data in the associated aggregating layer;
receive, from an index-server, a databank, and an associated storage weight;
add the databank as an aggregating-databank to the aggregating-datastore in an aggregating layer selected based on the associated storage weight.

16. A system for processing data of a computer network, the system comprising one or more computing devices comprising at least one processor and memory, the one or more computing devices configured to create:
a plurality of operation-services, each operation-service configured to perform operations that produce operation-data having at least two dimensions of information;
a second plurality of index-services, each index-service configured to:
maintain a datastore for the operation-data, the datastore comprising:
a ingestion buffer configured to store incoming operation- data;
one or more databanks configured to store operation-data, the databanks being arranged in one or more storage layers of the datastore;
for each storage layer, an associated storage weight that indicates a weight to be applied to each operation-data in the associated storage layer;
receive a stream of the incoming operation-data from at least some of the operation-services;
add the incoming operation-data to the ingestion buffer;
responsive to determining that the ingestion buffer contains sufficient incoming operation-data to be moved to a storage layer as a databank, move the ingestion buffer to a storage layer as a databank;
responsive to determining that the ingestion buffer contains sufficient incoming operation-data to be moved to a storage layer as a databank;
determine if a given storage layer contains sufficient databanks to be compacted and moved to a higher layer;
responsive to determining that the given storage layer contains sufficient databanks to be compacted:
combine each databank in the given layer into a databank- union;
identify pairs of operation-data in the databank-union based on a multidimensional distance measure between operation-data of the databank-union;
color a first operation-data of the pair a first color;
color a second operation-data of the pair a second color;
create in a higher storage layer, a new databank comprising the first operation-data of the first color while discarding the second operation-data of the second color.
